(19) United States
(12) Patent Application Publication
(10) Pub. No.: US 2015/0163732 A1
(43) Pub. Date: Jun. 11, 2015

(54) MULTI-USER CONGESTION DETECTION AND MITIGATION MECHANISM

(71) Applicant: MOTOROLA MOBILITY LLC, Libertyville, IL (US)

(72) Inventors: Daniel C. Chisu, Franklin Park, IL (US); William K. Morgan, Wauconda, IL (US)

(73) Assignee: MOTOROLA MOBILITY LLC, Libertyville, IL (US)

(21) Appl. No.: 14/143,557

(22) Filed: Dec. 30, 2013

Related U.S. Application Data
(60) Provisional application No. 61/914,408, filed on Dec. 11, 2013.

(51) Int. Cl. H04W 48/20; H04W 28/02

(52) U.S. Cl. CPC H04W 48/20; H04W 28/0289

(57) ABSTRACT

A method and system selects a serving cell based on call rejection information associated with registered user equipment (UEs). In particular, a UE initially registered with a first serving cell determines a first rejection rate for the first cell by tracking and evaluating call rejection information associated with the UE and neighbor UEs. If the first rejection rate is not greater than a threshold rejection rate, the UE transmits a connection request to a base station within the first cell. If the connection request fails, the UE searches, using call service redirection (CSR) information, for an alternate candidate serving cell with a low rejection rate. However, if the first rejection rate is greater than the threshold rejection rate, the UE determines whether an alternate candidate serving cell is identifiable using the CSR information. If the alternate candidate serving is identified, the UE attempts to register with the alternate candidate serving cell.

### BACKGROUND

1. Technical Field

The present disclosure relates in general to wireless communication devices and in particular to congestion management in wireless communication devices.

2. Description of the Related Art

As demand for wireless network services increase, wireless communication networks are tasked with handling increasing levels of wireless network traffic. As network traffic increases, wireless communication devices are reporting increasingly high rates of data stalls on various wireless communication networks. Analysis of mobile logs for devices registered on various wireless networks identifies a common trend associated with congestion issues in various types of networks including Long Term Evolution (LTE) and Wideband Code Division Multiple Access (WCDMA) network systems. In particular, wireless communication devices frequently fail to establish connection due to network rejection and are issued wait times that must expire before a connection request is retried. These rejected connection requests are typically due to network congestion. A clear indication that rejected connection requests are caused by network congestion is provided by rejection information provided by a number of wireless communication networks including WCDMA networks. It has also been observed that when a connection request is retried on the same cell, the retried request frequently fails. In many cases, connection requests fail repeatedly. Eventually a data stall gets triggered after a number of failed connection requests.

One of the issues associated with a frequent occurrence of data stalls is that the congestion environment and/or a lack of network resources is persistent in the short term. However, pre-established specifications for cell selection criteria only take into account downlink channel measurements.

### BRIEF DESCRIPTION OF THE DRAWINGS

The described embodiments are to be read in conjunction with the accompanying drawings, wherein:

FIG. 1 is a block diagram of an example user equipment (UE) and neighbor UEs within a wireless communication environment, within which the functional aspects of the described embodiments may be implemented;

FIG. 2 is a block diagram of an example UE, within which the functional aspects of the described embodiments may be implemented;

FIG. 3 is a block diagram of an example UE and neighbor UEs within a wireless communication environment having multiple wireless communication networks, according to one embodiment;

FIG. 4 is a table of call service redirection (CSR) data corresponding to a first UE and the neighbor UEs, according to one embodiment;

FIG. 5 is a flow chart illustrating one method for selecting a serving cell for wireless network service by using rejection rates and an evaluation of CSR data, according to one embodiment; and

FIG. 6 is a flow chart illustrating one method for selecting a serving cell for wireless network service from among a number of serving cells using a respective radio access technology (RAT) based on rejection rates and an evaluation of CSR data, according to one embodiment.

### DETAILED DESCRIPTION

The illustrative embodiments provide a method and system for selecting a serving cell based on call rejection information associated with registered user equipment (UEs). In particular, a UE initially registered with a first, serving cell determines a first rejection rate for the first cell by tracking and evaluating call rejection information associated with the UE and neighbor UEs. If the first rejection rate is not greater than a threshold rejection rate, the UE transmits a connection request to a base station within the first cell. If the connection request fails, the UE searches, using call service redirection (CSR) information, for an alternate candidate serving cell with a low rejection rate. However, if the first rejection rate is greater than the threshold rejection rate, the UE determines whether an alternate candidate serving cell, which is target for fulfilling a connection request, is identifiable using the CSR information. If the alternate candidate serving cell is identified, the UE attempts to register with the alternate candidate serving cell, bypassing the first cell.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present disclosure. The following detailed description is, therefore, not to be taken in a limiting sense, and the scope of the present disclosure is defined by the appended claims and equivalents thereof.

Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention.

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

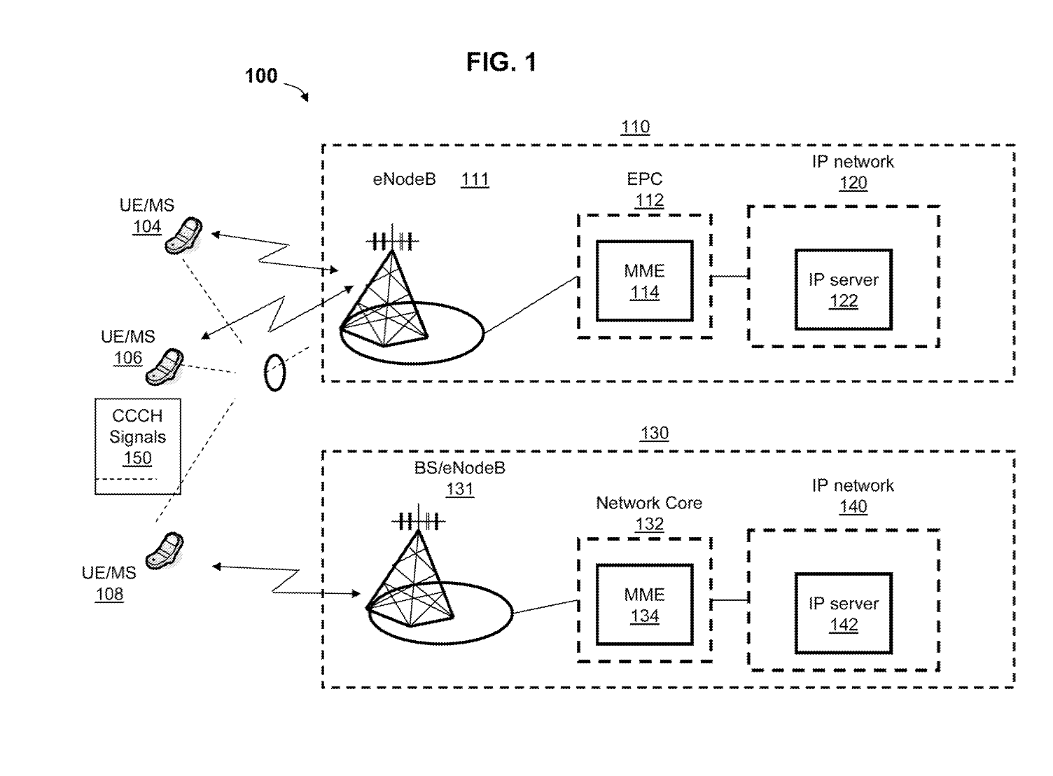

With specific reference now to FIG. 1, there is depicted a block diagram of an example user equipment (UE) and neighbor UEs within a wireless communication environment, within which the functional aspects of the described embodiments may be implemented. Wireless network environment (WNE) 100 comprises first wireless communication network (WCN) 110 which utilizes a first radio access technology (RAT), such as Long Term Evolution (LTE) technology. In addition, WNE 100 comprises multiple UEs (which are also referred to as “wireless communication devices”) including first UE 104, second UE 106 and third UE 108. A UE is also referred to as a mobile station (MS) or a mobile device, herein. First WCN 110 comprises an Evolved Node B (eNodeB/eNB) 111 by which UEs, including first UE 104, is able to access first WCN 110. First WCN 110 also comprises Evolved Packet Core (EPC) 112 which is communicatively coupled to eNodeB 111. In addition, first WCN 110 includes Internet Protocol (IP) network 120 which is communicatively coupled to EPC 112. As illustrated, EPC 112 includes Mobility Management Entity (MME) 114 which is a primary signaling node/component of EPC 112. Included within IP network 120 is IP server 122. First UE 104 and second UE 106 are able to detect and/or communicate with ENodeB 111. Illustrated within WNE 100 are broadcast/common control channel (CCCH) signals 150 which are broadcast control signals communicated over common control channels. These broadcast CCCH signals 150 are detectable to first UE 104 and neighbor UEs 106 and 108, which are located within a pre-established maximum distance from a corresponding base-station or eNodeB (e.g., eNodeB 111)

In one embodiment, WNE 100 also comprises second WCN 130. Second WCN 130 utilizes either the first RAT or a second/different RAT (e.g., Wideband Code Division Multiple Access (WCDMA) technology). Second WCN 130 has a similar architecture to that of first WCN 110. In particular, second WCN 130 comprises base-station (BS), NodeB 131, network core 132 and IP network 140. As illustrated, third UE 108 is able to detect and/or communicate with NodeB 131.

First UE 104 attempts to establish a call or data connection by first selecting a serving cell based on broadcasted call rejection information associated with first UE 104 and other UEs (106 and 108). For example, first UE 104 receives the broadcasted call rejection information via a common control channel. In one embodiment, first UE 104 determines a first rejection rate for the first cell by evaluating call rejection information associated with first UE 104 device and the neighbor UEs. With the descriptions herein, the first cell utilizes a first serving frequency, while the second cell, introduced later, utilizes a second serving frequency. First UE 104 receives call rejection information associated with other UEs via a shared broadcast control channel. In one embodiment, the received call rejection information includes channel quality information associated with downlink receive channels. First UE 104 is initially registered with a first cell, which is a candidate serving cell served by eNodeB 111. The term “candidate serving cell” is used to identify a serving cell that is targeted as a candidate for fulfilling a connection request. First UE 104 tracks call broadcasted service redirection (CSR) information associated with first UE 104 and the neighbor UEs. In addition, first UE 104 determines whether the first rejection rate for the first cell is greater than a threshold rejection rate. In response to the first rejection rate for the first cell not being greater than the threshold rejection rate, first UE 104 transmits a first connection request to a first base station within the first cell. However, in response to the first rejection rate for the first cell being greater than the threshold rejection rate, first UE 104 determines whether an alternate candidate serving cell is identifiable using the CSR information. In response to an alternate candidate serving being identifiable using the CSR information, first UE 104 attempts to register with the alternate candidate serving cell.

First UE 104 stores the tracked CSR information, which includes most recent CSR information. First UE 104 determines, from the most recent CSR information, a number of CSR parameter values, including redirect serving frequencies and wait intervals, associated with first UE 104 and the neighbor UEs. Furthermore, first UE 104 updates the stored CSR information, including the redirect serving frequencies and the wait intervals, in response to at least one of (a) acceptance of a connection request, (b) rejection of a connection request, and (c) expiration of an update waiting period. First UE 104 uses the stored CSR information to identify candidate serving cells.

In one embodiment, first UE 104 determines, using the stored CSR information, at least one of (i) a preferred set of ordered candidate serving cells which are associated with lower rejection rates and (ii) a non-preferred set of cells which are associated with higher rejection rates. The preferred set of ordered candidate serving cells is arranged from most ideal to least ideal candidate serving cell according to corresponding rejection rates. First UE 104 selects, as the alternate candidate serving cell, a second cell that is at least one of (a) excluded from the non-preferred set of cells and (b) included within the preferred set of candidate serving cells.

By selecting a serving cell using call rejection information and CSR information, first UE 104 avoids re-attempting connection requests for resources which may not be available for a particular time interval. As a result, first UE 104 achieves gains in current drain performance, enhances user experience, and reduces interference.

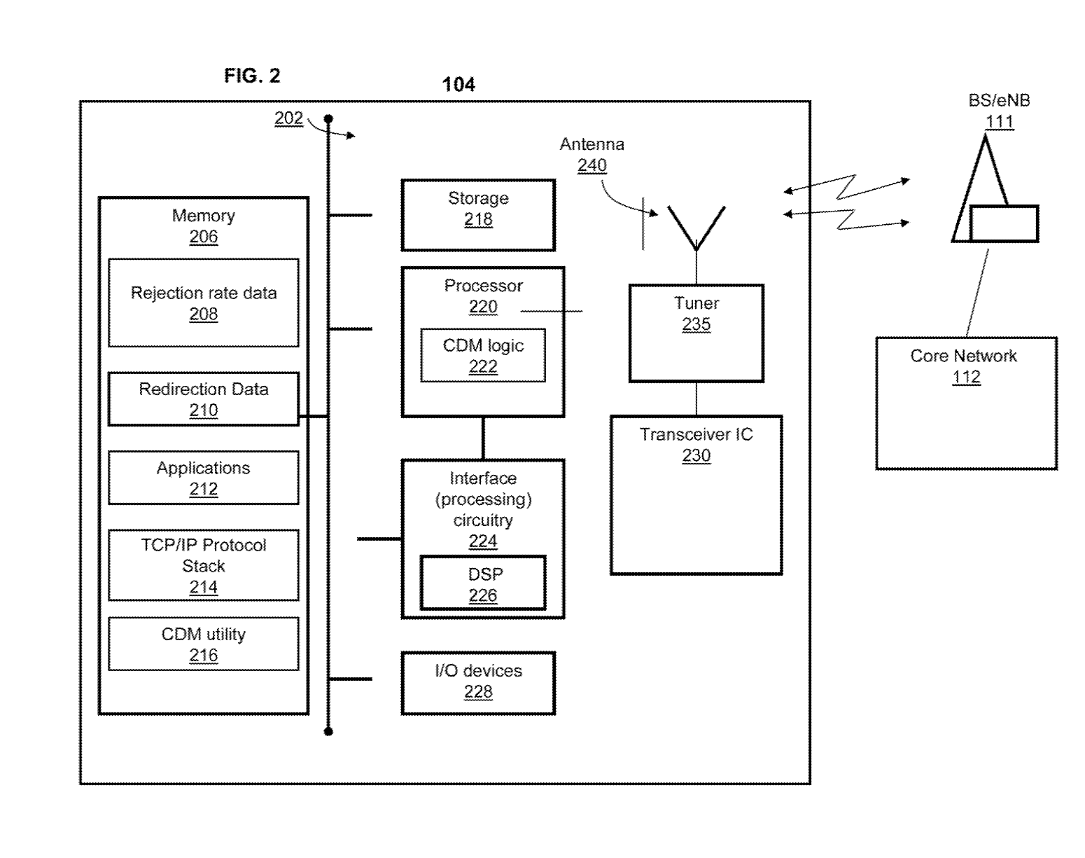

FIG. 2 is a block diagram of an example UE, within which the functional aspects of the described embodiments may be implemented. User equipment 104 represents a device that is adapted to transmit and receive electromagnetic signals over an air interface via uplink and/or downlink channels between the user equipment 104 and communication network equipment (e.g., base-station 111) utilizing at least one communication standard, such as Global System for Mobile Communications (GSM), Code Division Multiple Access (CDMA), Orthogonal Frequency Division Multiple Access (OFDMA), Long Term Evolution (LTE), Wireless Local Area Networks (WLAN) (e.g. WiFi) and other wireless communication systems. In one or more embodiments, the user equipment can be a mobile cellular device/phone or smartphone, or laptop, netbook or tablet computing device, or other types of communications devices.

User equipment 104 comprises processor 220 and interface circuitry 224, which are connected to memory component 206 via signal bus 202. Interface circuitry 224 includes digital signal processor (DSP) 226. In addition, user equipment 104 comprises input/output (I/O) devices 228. Also included within user equipment 104 are transceiver IC 230 and tuner 235 which is communicatively coupled to transceiver IC 230.

In at least some embodiments, the sending and receiving of RF communication signals occur wirelessly and are facilitated by one or more antennas/antenna elements 240 communicatively coupled to tuner 235. The number of antenna elements can vary from device to device, ranging from one or more antenna elements and the presentation within user equipment 104 of a particular number (e.g., N) of antenna elements is merely for illustration.

User equipment 104 is able to wirelessly communicate with multiple base-stations including base-station 111 via one or more antennas (e.g., antenna 140). Each of the multiple base-stations (e.g., base station 111) can be any one of a number of different types of network stations and/or antennas associated with the infrastructure of the wireless network and configured to support uplink and downlink communication via one or more of the wireless communication protocols supported by a respective wireless network core such as core network 112, as known by those skilled in the art.

In addition to the above described hardware components of user equipment 104, various features of the invention may be completed or supported via software or firmware code and/or logic stored within at least one of memory 206 and respectively executed by DSP 226 or processor 220. Thus, for example, included within system memory 206 are a number of software, firmware, logic components, modules, or data, including rejection rate data 208, call service redirection (CSR) data 210, Applications 212, Transmission Control Protocol/Internet Protocol (TCP/IP) Protocol Stack 214 and congestion detection and mitigation (CDM) utility 216.

The various components within user equipment 104 can be electrically and/or communicatively coupled together as illustrated in FIG. 2. As utilized herein, the term “communicatively coupled” means that information signals are transmissible through various interconnections between the components. The interconnections between the components can be direct interconnections that include conductive transmission media, or may be indirect interconnections that include one or more intermediate electrical components. Although certain direct interconnections are illustrated in FIG. 2, it is to be understood that more, fewer or different interconnections may be present in other embodiments.

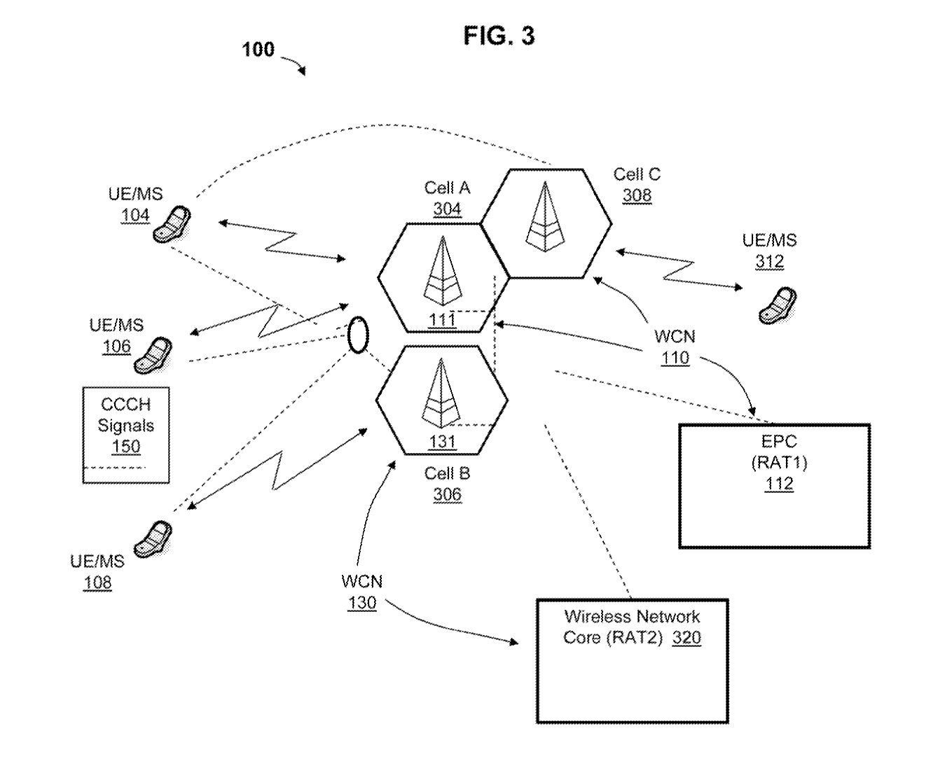

FIG. 3 is a block diagram of an example user equipment and neighbor UEs within a wireless communication environment having multiple wireless communication networks, according to one embodiment. Wireless network environment (WNE) 100 comprises first wireless communication network (WCN) 110 which utilizes a first radio access technology (RAT), such as LTE technology. In addition, WNE 100 comprises multiple UEs including first UE 104, second UE 106, third UE 108 and fourth UE 312. First WCN 110 comprises serving cell “A” 304 which includes eNodeB 111. First WCN 110 also comprises serving cell “C” 308. First WCN 110 also comprises Evolved Packet Core (EPC) 112 which is communicatively coupled to serving cell “A” 304 and serving cell “C” 308. First UE 104 and second UE 106 are able to detect and/or communicate with serving cell “A” 304 via eNodeB 111. Illustrated within WNE 100 are broadcast/common control channel (CCCH) signals 150 which are broadcast control signals communicated over common control channels.

In one embodiment, WNE 100 also comprises second WCN 130. Second WCN 130 utilizes either the first RAT or a second/different RAT (e.g., WCDMA technology). Second WCN 130 has a similar architecture to that of first WCN 110. Second WCN 130 comprises serving cell “B”, which includes base-station (BS)/NodeB 131 and network core/second/EPC 132. As illustrated, third UE 108 is able to detect and/or communicate with serving cell “B” 306 via NodeB 131.

First UE 104 attempts to establish a call or data connection by first selecting a serving cell based on tracked CSR information associated with first UE 104 and other UEs (e.g., 106 and 108). First UE 104 determines, using the tracked CSR information, whether the first rejection rate for the first cell (e.g., serving cell “A” 304) is greater than a threshold rejection rate. In response to the first rejection rate for the first cell not being greater than the threshold rejection rate, first UE 104 transmits a first connection request to a first base station (e.g., eNodeB 111) within the first cell.

In response to a connection request from the first UE 104 being rejected, first UE 104 initiates, using a wait interval assigned by a corresponding base station (e.g., eNodeB 111), a waiting period before the first UE 104 can transmit another connection request to a same serving cell (e.g., serving cell “A” 304). If the waiting period expires and (i) first UE 104 fails to register with a next serving cell and/or (ii) first UE 104 receives a rejection of a connection request to an alternate candidate serving cell, first UE 104 transmits a next connection request to the same serving cell.

In one embodiment, first UE 104 determines whether an alternate candidate serving cell (e.g., serving cell “C” 308), which utilizes a next serving frequency detected by the first UE, is identifiable using the CSR information. In particular, first UE 104 determines whether the CSR information can be used to identify a next cell as an alternate candidate serving cell having at least one of (a) a rejection rate that is not greater than the threshold rejection rate and (b) a wait time that is not greater than a first wait time corresponding to the first serving cell. Following a determination that the CSR information does not identify a next cell as an alternate candidate serving cell, first UE 104 transmits a connection request to the first cell. In response to determining that the CSR information identifies a next cell as the alternate candidate serving cell, first UE 104 initiates registration with the next cell. In response to determining that the next cell is an alternate candidate serving cell, first UE 104 initiates registration with the next cell. In response to the first UE successfully registering with the next cell, first UE 104 transmits a connection request to a next base station within the next cell.

If (i) the first UE does not successfully register with an alternate candidate serving cell or (ii) a connection request from the first UE is rejected by an alternate candidate serving cell, first UE 104 continues to search for a next alternate candidate serving cell that is detected by the first UE and which is associated with at least one of (a) a lower wait time and (b) a lower congestion level. The next alternate candidate serving cell can utilize one of (a) a same, first radio access technology (RAT) of the first cell and (b) a second RAT that is different from the first RAT.

If the first connection request is rejected, first UE 104 determines whether the CSR information indicates that a second cell, which utilizes a second serving frequency that is detected by the first UE, is an alternate candidate serving cell. First UE 104 determines whether a first wait time, associated with a rejection of the first connection request from the first UE, exceeds a pre-established threshold wait time.

If the first wait time exceeds the pre-established threshold wait time, first UE 104 determines whether a second cell that is detected by the first UE has a second lower wait time. If a second cell has a second lower wait time, first UE 104 identifies the second cell as an alternate candidate serving cell. If the second cell is not associated with a second lower wait time, first UE 104 continues to search for an alternate candidate serving cell having a lower wait time than the first wait time.

If the first wait time does not exceed the pre-established threshold wait time, first UE 104 determines whether another cell that is detected by the first UE has a second lower congestion level. If the other detected cell has the second lower congestion level, first UE 104 identifies the other detected cell as the alternate candidate serving cell. If the other detected cell does not have a second lower congestion level, first UE 104 continues to search for an alternate candidate serving cell that is associated with a lower congestion level than the first congestion level. In response to identifying a detected cell as an alternate candidate serving cell, first UE 104 initiates registration with the detected cell. If the first UE successfully registers with the detected cell, first UE 104 transmits a connection request to a base station corresponding to the detected cell.

In one embodiment, first UE 104 calculates rejection rates of detected serving cells, and specifically corresponding to each detected serving frequency of each serving cell. The calculated rejection rates for each serving frequency and serving cell can be further mapped to a RAT utilized by a respective serving cell. First UE 104 calculates rejection rates including the first rejection rate corresponding to the first serving cell. Specifically, first UE 104 calculates the rejection rate from a ratio of (a) a number of resource connection rejections issued by a corresponding serving cell to respective UEs and (b) a threshold time interval. First UE 104 stores the calculated rejection rates and updates the stored rejection rates following at least one of (a) a preset update interval and (b) detection of a resource connection rejection associated with at least one of the other UEs.

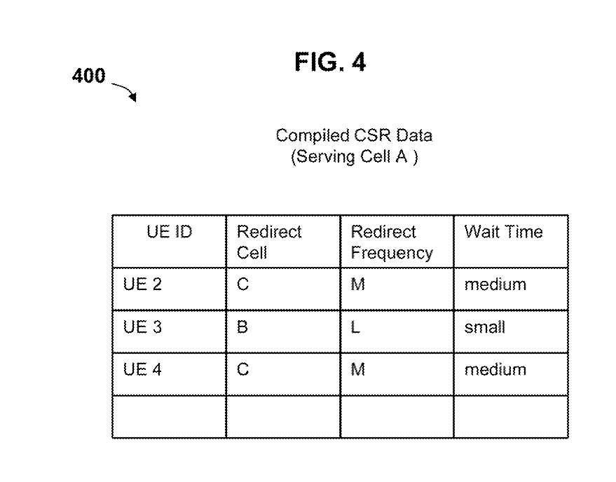

FIG. 4 is a table of service redirection data corresponding to a first UE and the neighbor UEs, according to one embodiment. In a first WCN 110 (e.g., an LTE network), service redirection information associated with other serving cells is not explicitly provided within a rejection notification. However, the rejection notification provides a wait-time associated with the serving cell which rejected the corresponding connection request. Thus, the UE is able to compile wait times associated with various serving cells if the UE is able to detect rejection messages respectively broadcasted by the various serving cells. In one or more related embodiments, the UE maps compiled wait times to detected serving cells and corresponding serving frequencies to provide UE generated redirection information. In the related embodiment(s), the UE generated redirection information does not identify a redirect frequency for the neighbor UEs since the rejecting cell does not explicitly provide service redirection information. However, in a second WCN 130 (e.g., a WCDMA network), service redirection information is provided within a rejection notification to a connection request. In particular, first UE 104 receives the service redirection information or rejection notification messages used to provide “redirection information” via the broadcast control channel and stores/updates the respective redirection information which is compiled within first UE 104.

In one embodiment, service redirection information comprises (a) identification of a serving cell to which a UE is (or can be) redirected in response to a call connection request being rejected, (b) identification of a serving frequency to which a UE is (or can be) redirected in response to a call connection request being rejected and (c) a wait time value assigned to a UE in response to a call connection request being rejected.

Table 400 provides a compilation of redirection information (e.g., CSR information issued by serving cell “A” for respective UEs). In one embodiment, service redirection information 214 is broadcasted by serving cell “A” over a control channel accessible to first UE 104 and neighbor UEs. The first column of table 400 provides UE identification (UE ID) for UEs respectively associated with service redirection information. The second column identifies redirect serving cells to which UEs are directed. The third column identifies redirect serving frequencies to which UEs are directed. The fourth column identifies wait times assigned to respective UEs.

Table 400 includes multiple rows, of which first row 402, second row 404 and third row 406 are identified. First row 402 indicates that second UE 106 was redirected by serving cell “A” to serving cell “C.” Specifically, first row 402 indicates that second UE 106 was redirected to redirect frequency “M” of serving cell “C.” In addition, second UE 106 is assigned a “medium” wait time.

Second row 404 indicates that third UE 108 was redirected by serving cell “A” to serving cell “B.” In particular, third UE 108 was redirected to redirect frequency “L” of serving cell “B.” In addition, third UE 108 is assigned a “small” wait time.

Third row 406 indicates that fourth UE 312 was redirected by serving cell “A” to serving cell “C.” Specifically, fourth UE 312 was redirected to redirect frequency “M” of serving cell “C.” In addition, fourth UE 312 is assigned a “medium” wait time.

In WCN 110, first UE 104 calculates the first rejection rate for the first cell. If the first rejection rate is greater than the threshold rejection rate, first UE 104 does not send a connection request to the first cell. However, first UE 104 determines whether the CSR information (e.g., Table 400) identifies a next cell as an alternate candidate serving cell, which utilizes a next serving frequency that first UE 104 can detect. In particular, first UE 104 determines whether the next cell has at least one of (a) a rejection rate that is not greater than the threshold rejection rate and (b) a wait time that is not greater than a first wait time corresponding to the first serving cell.

With reference again to table 400, first UE 104 identifies an alternate candidate serving cell from among the serving cells (e.g., serving cells “B” and “C”) to which UEs are redirected in response to corresponding call connection requests being rejected. In one embodiment, first UE 104 uses table 400 to identify a redirect serving cell to which most UEs are redirected. First UE 104 is able to determine a rejection rate for a most frequently assigned redirect serving cell by utilizing compiled CSR data corresponding to the most frequently assigned redirect serving call. For example, first UE 104 determines, using table 400, that serving cell “C” is a most frequently assigned redirect serving cell. First UE 104 then determines a rejection rate for serving cell “C” by utilizing compiled CSR data corresponding to serving cell “C”. In one implementation, first UE 104 stores compiled CSR data corresponding to serving cell “C” in another table. In one embodiment, first UE 104 compiles CSR information issued by various serving cells that are detectable by first UE 104.

More generally, following a determination, using the CSR information, that first UE 104 does not identify a next cell as an alternate candidate serving cell, first UE 104 transmits a connection request to the first cell. In response to determining, using the CSR information, that first UE 104 identifies a next cell as the alternate candidate serving cell, first UE 104 initiates registration with the next cell. In response to the first UE successfully registering with the next cell, first UE 104 transmits a connection request to a next base station within the next cell.

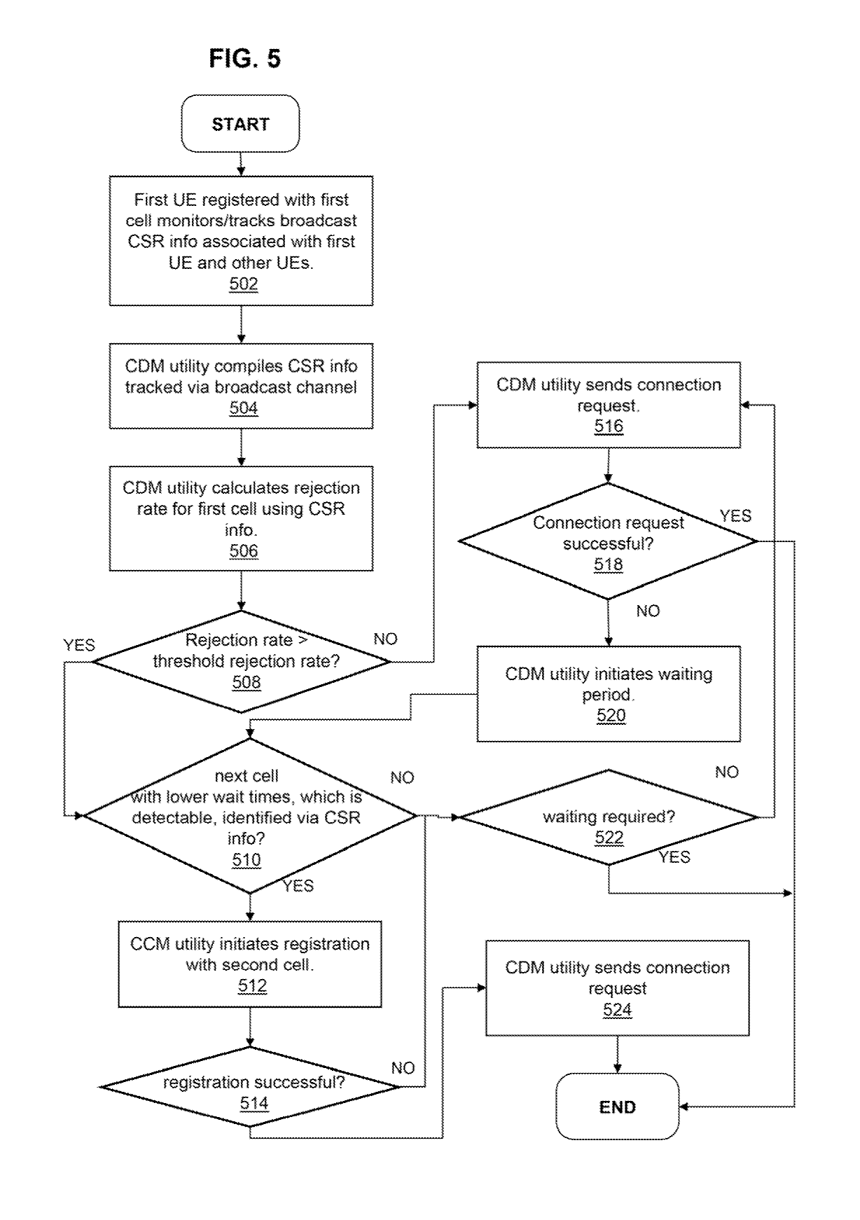

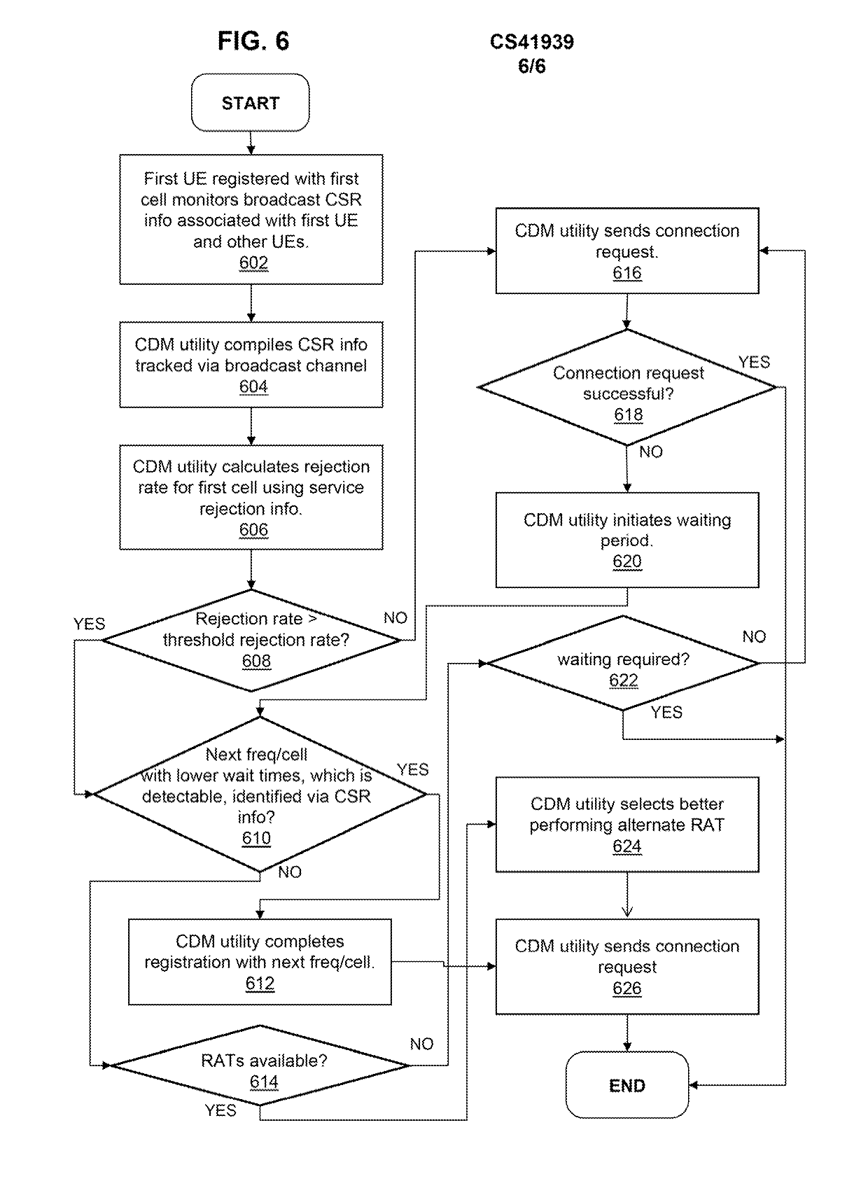

FIGS. 5 and 6 are flow charts illustrating embodiments of the method by which the above processes of the illustrative embodiments can be implemented. Specifically, FIG. 5 illustrates a method for selecting a serving cell for wireless network service by using rejection rates and an evaluation of CSR data. FIG. 6 illustrates a method for selecting a serving cell for wireless network service from among a number of serving cells using a respective radio access technology (RAT), based on rejection rates and an evaluation of CSR data. In one embodiment, the method of FIG. 5 specifically applies to a first type of wireless communication network such as a wide-band code division multiple access (WCDMA) network. In one or more related embodiments, the CSR data are included within a rejection message (e.g., an RRC connection rejection message) corresponding to a connection request. In another embodiment, the method of FIG. 6 specifically applies to a second type of wireless communication network such as a Long Term Evolution (LTE) network. In one or more related embodiments, the CSR data are not explicitly provided by the network within the rejection message corresponding to a connection request. As a result, in the LTE network, the UE is able to directly determine “redirection information” by retrieving information including wait-time data from broadcasted rejection messages from respective serving cells. The UE uses the redirection information to guide the UE during a selection of an alternate serving cell. For example, the UE attempts to properly detect (i.e., via an adequate received signal strength) and register with another serving cell having an adequate wait-time.

Although the methods illustrated by FIGS. 5 and 6 may be described with reference to components and functionality illustrated by and described in reference to FIGS. 1-4, it should be understood that this is merely for convenience and alternative components and/or configurations thereof can be employed when implementing the method. Certain portions of the methods may be completed by CDM utility 216 executing on one or more processors (FIG. 2). The executed processes then control specific operations of UE 104. For simplicity is describing the method, all method processes are described from the perspective CDM utility 216 and UE 104.

The method of FIG. 5 begins at initiator block 501 and proceeds to block 502 at which first UE 104, which is registered with first cell 304, monitors or tracks broadcast CSR information associated with first UE 104 and other, neighbor UEs. At block 504, CDM utility 216 compiles CSR information tracked or received via the common control channel. At block 506, CDM utility 216 calculates a rejection rate for first cell 304 using the CSR information. At decision block 508, CDM utility 216 determines whether the rejection rate is greater than a threshold rejection rate. If at decision block 508 CDM utility 216 determines that the rejection rate is greater than the threshold rejection rate, CDM utility 216 determines, at decision block 510, whether a next cell, which is detectable and has lower wait times, can be identified using the CSR information. For example, the next serving cell is identified as a detectable cell if CDM utility 216 determines that UE 104 is able to detect an RF signal corresponding to a serving frequency of the next serving cell. UE 104 is able to detect the RF signal when the detected RF signal has an acceptable receive signal strength. To determine whether the next serving cell has a lower wait time, CDM utility 216 compares, using CSR data 210, a wait time for the first serving cell, which rejected a previous connection request, to a wait time for the next serving cell. If at decision block 508 CDM utility 216 determines that the rejection rate is not greater than the threshold rejection rate, CDM utility 216 sends a connection request to the first cell, as shown at block 516.

If at decision block 510 CDM utility 216 determines that a next detectable cell with lower wait times can be identified using the CSR information, CDM utility 216 initiates registration with the next cell, as shown at block 512. At decision block 514, CDM utility 216 determines whether the registration with the next cell was successful. If CDM utility 216 determines at decision block 514 that the registration with the next cell was successful, CDM utility 216 sends a connection request, as shown at block 524. If CDM utility 216 determines at decision block 514 that the registration with the next cell was not successful, CDM utility 216 determines at decision block 522 whether a waiting period before re-transmitting a connection request to the first cell is required (or has not yet expired). At decision block 518, CDM utility 216 determines whether the connection request was rejected and, in one embodiment, whether the wait-time exceeds a pre-established threshold wait-time (if the connection request was rejected). If at decision block 518, CDM utility 216 determines that the connection request was rejected and the corresponding wait-time exceeds the pre-established threshold wait-time, CDM utility 216 initiates a waiting period using the corresponding CSR information, as shown at block 520. If at decision block 518, CDM utility 216 determines that the connection request was successful, the process moves to end block 526.

If at decision block 510 CDM utility 216 determines that a next detectable cell with lower wait times cannot be identified using the CSR information, CDM utility 216 determines at decision block 522 whether a waiting period before re-transmitting a connection request to the first cell is required (or has not yet expired). If at decision block 522 CDM utility 216 determines that the waiting period before re-transmitting a connection request to the first cell is not required (or has expired), the process returns to block 516 at which CDM utility 216 sends another connection request to the first cell. If at decision block 522 CDM utility 216 determines that the waiting period before re-transmitting a connection request to the first cell is required (or has not yet expired), the process proceeds to end block 526. However, in another embodiment, if the waiting period before re-transmitting a connection request to the first cell is required (or has not yet expired), CDM utility 216 searches for an alternate serving cell which uses a different RAT and sends a connection request to the alternate serving cell. The process ends at block 526.

The method of FIG. 6 begins at initiator block 601 and proceeds to block 602 at which first UE 104, which is registered with first cell 304, monitors or tracks broadcast rejection messages associated with first UE 104 and other, neighbor UEs. At block 604, CDM utility 216 compiles redirection information using information such as wait-times that are retrieved from the rejection messages tracked or received via the common control channel. At block 606, CDM utility 216 calculates a rejection rate for first cell 304 using the compiled redirection information. At decision block 608, CDM utility 216 determines whether the rejection rate is greater than a threshold rejection rate. If at decision block 608 CDM utility 216 determines that the rejection rate is not greater than the threshold rejection rate, CDM utility 216 sends a connection request to the first cell, as shown at block 616. If at decision block 608 CDM utility 216 determines that the rejection rate is greater than the threshold rejection rate, CDM utility 216 determines, at decision block 610, whether a next cell and/or a next detectable serving frequency with lower wait times can be identified using the compiled redirection information. If at decision block 610 CDM utility 216 determines that a next (detectable) cell and/or a next serving frequency with lower wait times can be identified using the compiled redirection information, CDM utility 216 completes registration with the next cell and/or next frequency, as shown at block 612. If at decision block 610 CDM utility 216 determines that a next (detectable) cell and/or a next serving frequency with lower wait times, cannot be identified using the compiled redirection information, CDM utility 216 determines, at decision block 614, whether any other serving cells using a different RAT is available.

If at decision block 614 CDM utility 216 determines that at least one alternate serving cell using a different RAT is available, CDM utility 216 selects a better performing RAT, based on detected signal power, from among the available RATs, as shown at block 624. CDM utility 216 sends a connection request to the selected serving cell, as shown at block 626. However, if at decision block 614 CDM utility 216 determines that no alternate serving cells using a different RAT are available, CDM utility 216 determines, at decision block 622, whether a waiting period before re-transmitting a connection request to the first cell is required (or has not yet expired). If at decision block 622 CDM utility 216 determines that the waiting period before re-transmitting a connection request to the first cell is not required (or has expired), the process returns to block 616 at which CDM utility 216 sends another connection request to the first cell. If at decision block 622 CDM utility 216 determines that the waiting period before re-transmitting a connection request to the first cell is required (or has not yet expired), the process proceeds to end block 628.

At decision block 618, CDM utility 216 determines whether the connection request was rejected and, in one embodiment, whether the wait-time exceeds a pre-established threshold wait-time (if the connection request was rejected). If at decision block 618, CDM utility 216 determines that the connection request was rejected and the wait-time exceeds the pre-established threshold wait-time, CDM utility 216 initiates a waiting period using the compiled redirection information, as shown at block 620. If at decision block 618, CDM utility 216 determines that the connection request was successful, the process moves to end block 628.

The flowchart and block diagrams in the various figures presented and described herein illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Thus, while the method processes are described and illustrated in a particular sequence, use of a specific sequence of processes is not meant to imply any limitations on the disclosure. Changes may be made with regards to the sequence of processes without departing from the spirit or scope of the present disclosure. Use of a particular sequence is therefore, not to be taken in a limiting sense, and the scope of the present disclosure extends to the appended claims and equivalents thereof.

In some implementations, certain processes of the methods are combined, performed simultaneously or in a different order, or perhaps omitted, without deviating from the spirit and scope of the disclosure. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method within a first user equipment (UE) for selecting a serving cell based on call rejection information associated with the first UE and other UEs, the method comprising:
determining a first rejection rate for a first cell that utilizes a first serving frequency by evaluating call rejection information associated with the first UE and the other UEs, wherein the first UE is initially registered with the first cell which is a candidate serving cell;
tracking call service redirection (CSR) information associated with the first UE and the other UEs;
determining whether the first rejection rate for the first cell is greater than a threshold rejection rate;
in response to the first rejection rate for the first cell not being greater than the threshold rejection rate, transmitting a first connection request to a first base station within the first cell; and
in response to the first rejection rate for the first cell being greater than the threshold rejection rate:
determining whether an alternate candidate serving cell is identifiable using the CSR information; and
in response to an alternate candidate serving being identifiable using the CSR information, attempting to register with the alternate candidate serving cell.

2. The method of claim 1, further comprising:
storing the tracked CSR information which includes a most recent CSR information;
determining, from the most recent CSR information, a number of call service redirection (CSR) parameter values, including redirect serving frequencies and wait intervals, associated with the first UE and the other UEs; and
updating the stored CSR information including the redirect serving frequencies and the wait intervals, in response to at least one of (a) acceptance of a connection request, (b) rejection of a connection request, and (c) expiration of an update waiting period, wherein the record of CSR information is used to identify candidate serving cells.

3. The method of claim 2, further comprising:
determining, using the stored CSR information, at least one of (i) a preferred set of ordered candidate serving cells which are associated with lower rejection rates and (ii) a non-preferred set of cells which are associated with higher rejection rates, wherein the preferred set of ordered candidate serving cells is arranged from most ideal to least ideal candidate serving cell according to corresponding rejection rates; and
selecting, as the alternate candidate serving cell, a second cell that is at least one of (a) excluded from the non-preferred set of cells and (b) included within the preferred set of candidate serving cells.

4. The method of claim 2, further comprising:
in response to a connection request from the first UE being rejected, initiating, using a wait interval assigned by a corresponding base station, a waiting period before the first UE can transmit another connection request to a same serving cell; and
in response to the waiting period expiring and at least one of (i) the first mobile failing to register with a next serving cell and (ii) the first mobile receiving a rejection of a connection request to an alternate candidate serving cell, transmitting a next connection request to the same serving cell.

5. The method of claim 2, wherein said determining whether an alternate candidate serving cell is identifiable using the CSR information further comprises:
determining whether the CSR information identifies a next cell as an alternate candidate serving cell, which utilizes a next serving frequency detected by the first UE, and which has at least one of (a) a rejection rate that is not greater than the threshold rejection rate and (b) a wait time that is not greater than a first wait time corresponding to the first serving cell;
following a determination that the CSR information does not identify a next cell as an alternate candidate serving cell, transmitting a connection request to the first cell;
in response to determining that the CSR information identifies a next cell as the alternate candidate serving cell, initiating registration with the next cell; and
in response to the first UE successfully registering with the next cell, transmitting a connection request to a next base station within the next cell.

6. The method of claim 2, further comprising:
in response to one of (i) the first UE not successfully registering with an alternate candidate serving cell and (ii) a connection request from the first UE being rejected by an alternate candidate serving cell, continuing to search for a next alternate candidate serving cell that is detected by the first UE and which is associated with at least one of (a) a lower wait time and (b) a lower congestion level;
wherein the next alternate candidate serving cell utilizes one of (a) a same, first radio access technology (RAT) of the first cell and (b) a second RAT that is different from the first RAT.

7. The method of claim 2, further comprising:
in response to the first connection request being rejected, determining whether the CSR information indicates that a second cell, which utilizes a second serving frequency detected by the first UE, is an alternate candidate serving cell, wherein said determining further comprises:
determining whether a first wait time, associated with a rejection of the first connection request from the first UE, exceeds a pre-established threshold wait time;
in response to the first wait time exceeding the pre-established threshold wait time:
determining whether a second cell that is detected by the first UE has a second lower wait time;
in response to determining that a second cell has a second lower wait time, identifying the second cell as an alternate candidate serving cell; and
in response to determining that a second cell is not associated with a second lower wait time, continuing to search for an alternate candidate serving cell having a lower wait time than the first wait time.

8. The method of claim 7, further comprising:
in response to the first wait time not exceeding the pre-established threshold wait time:
determining whether another cell that is detected by the first UE has a second lower congestion level;
in response to determining that the other detected cell has the second lower congestion level, identifying the other detected cell as the alternate candidate serving cell; and
in response to determining that the other detected cell does not have a second lower congestion level, continuing to search for an alternate candidate serving cell that is associated with a lower congestion level than the first congestion level;
in response to identifying a detected cell as an alternate candidate serving cell, initiating registration with the detected cell; and
in response to the first UE successfully registering with the detected cell, transmitting a connection request to a base station corresponding to the detected cell.

9. The method of claim 1, further comprising:
calculating rejection rates for detected serving cells based on each detected serving frequency of each serving cell, according to each RAT utilized by a respective serving cell, wherein said calculating rejection rates include calculating the first rejection rate corresponding to the first serving cell;
wherein a rejection rate is calculated from a ratio of (a) a number of resource connection rejections issued by a corresponding serving cell to respective UEs and (b) a threshold time interval;
storing the calculated rejection rates; and
updating the stored rejection rates following at least one of (a) a preset update interval and (b) detection of a resource connection rejection associated with at least one of the other UEs.

10. The method of claim 1, further comprising:
receiving call rejection information associated with other UEs via a shared broadcast control channel, wherein said received call rejection information includes channel quality information associated with downlink receive channels.

11. A user equipment (UE) comprising:
at least one processor;
at least one transceiver; and
a utility which when executed by the at least one processor configures the UE to:
determine a first rejection rate for a first cell that utilizes a first serving frequency by evaluating call rejection information associated with the first UE and the other UEs, wherein the first UE is initially registered with the first cell which is a candidate serving cell;
track call service redirection (CSR) information associated with the first UE and the other UEs;
determine whether the first rejection rate for the first cell is greater than a threshold rejection rate;
in response to the first rejection rate for the first cell not being greater than the threshold rejection rate, transmit a first connection request to a first base station within the first cell; and
in response to the first rejection rate for the first cell being greater than the threshold rejection rate:
determine whether an alternate candidate serving cell is identifiable using the CSR information; and
in response to an alternate candidate serving being identifiable using the CSR information, attempt to register with the alternate candidate serving cell.

12. The UE of claim 11, wherein the utility further configures the device to:
store the tracked CSR information which includes a most recent CSR information;
determine, from the most recent CSR information, a number of call service redirection (CSR) parameter values, including redirect serving frequencies and wait intervals, associated with the first UE and the other UEs; and
update the stored CSR information including the redirect serving frequencies and the wait intervals, in response to at least one of (a) acceptance of a connection request, (b) rejection of a connection request, and (c) expiration of an update waiting period, wherein the record of CSR information is used to identify candidate serving cells.

13. The UE of claim 12, wherein the utility further configures the device to:
determine, using the stored CSR information, at least one of (i) a preferred set of ordered candidate serving cells which are associated with lower rejection rates and (ii) a non-preferred set of cells which are associated with higher rejection rates, wherein the preferred set of ordered candidate serving cells is arranged from most ideal to least ideal candidate serving cell according to corresponding rejection rates; and
select, as the alternate candidate serving cell, a second cell that is at least one of (a) excluded from the non-preferred set of cells and (b) included within the preferred set of candidate serving cells.

14. The UE of claim 12, wherein the utility further configures the device to:
in response to a connection request from the first UE being rejected, initiate, using a wait interval assigned by a corresponding base station, a waiting period before the first UE can transmit another connection request to a same serving cell; and
in response to the waiting period expiring and at least one of (i) the first mobile failing to register with a next serving cell and (ii) the first mobile receiving a rejection of a connection request to an alternate candidate serving cell, transmit a next connection request to the same serving cell.

15. The UE of claim 12, wherein the utility further configures the device to:
determine whether the CSR information identifies a next cell as an alternate candidate serving cell, which utilizes a next serving frequency detected by the first UE, and which has at least one of (a) a rejection rate that is not greater than the threshold rejection rate and (b) a wait time that is not greater than a first wait time corresponding to the first serving cell;
following a determination that the CSR information does not identify a next cell as an alternate candidate serving cell, transmit a connection request to the first cell;
in response to determining that the CSR information identifies a next cell as the alternate candidate serving cell, initiate registration with the next cell; and
in response to the first UE successfully registering with the next cell, transmit a connection request to a next base station within the next cell.

16. The UE of claim 12, wherein the utility further configures the device to:
in response to one of (i) the first UE not successfully registering with an alternate candidate serving cell and (ii) a connection request from the first UE being rejected by an alternate candidate serving cell, continue to search for a next alternate candidate serving cell that is detected by the first UE and which is associated with at least one of (a) a lower wait time and (b) a lower congestion level;
wherein the next alternate candidate serving cell utilizes one of (a) a same, first radio access technology (RAT) of the first cell and (b) a second RAT that is different from the first RAT.

17. The UE of claim 12, wherein the utility further configures the device to:
in response to the first connection request being rejected, determine whether the CSR information indicates that a second cell, which utilizes a second serving frequency detected by the first UE, is an alternate candidate serving cell, wherein said determining further comprises:
determine whether a first wait time, associated with a rejection of the first connection request from the first UE, exceeds a pre-established threshold wait time;
in response to the first wait time exceeding the pre-established threshold wait time:
determine whether a second cell that is detected by the first UE has a second lower wait time;
in response to determining that a second cell has a second lower wait time, identify the second cell as an alternate candidate serving cell; and
in response to determining that a second cell is not associated with a second lower wait time, continue to search for an alternate candidate serving cell having a lower wait time than the first wait time.

18. The UE of claim 17, wherein the utility further configures the device to:
in response to the first wait time not exceeding the pre-established threshold wait time:
determine whether another cell that is detected by the first UE has a second lower congestion level;
in response to determining that the other detected cell has the second lower congestion level, identify the other detected cell as the alternate candidate serving cell; and
in response to determining that the other detected cell does not have a second lower congestion level, continue to search for an alternate candidate serving cell that is associated with a lower congestion level than the first congestion level;
in response to identifying a detected cell as an alternate candidate serving cell, initiate registration with the detected cell; and
in response to the first UE successfully registering with the detected cell, transmit a connection request to a base station corresponding to the detected cell.

19. The UE of claim 11, wherein the utility further configures the device to:
calculate rejection rates for detected serving cells based on each detected serving frequency of each serving cell, according to each RAT utilized by a respective serving cell, wherein said calculating rejection rates include calculating the first rejection rate corresponding to the first serving cell;
wherein a rejection rate is calculated from a ratio of (a) a number of resource connection rejections issued by a corresponding serving cell to respective UEs and (b) a threshold time interval;
store the calculated rejection rates; and
update the stored rejection rates following at least one of (a) a preset update interval and (b) detection of a resource connection rejection associated with at least one of the other UEs.

20. The UE of claim 11, wherein the utility further configures the device to:
receive call rejection information associated with other UEs via a shared broadcast control channel, wherein said received call rejection information includes channel quality information associated with downlink receive channels.
